(19) United States
(12) Patent Application Publication
(10) Pub. No.: US 2008/0078189 A1
(43) Pub. Date: Apr. 3, 2008

(54) Communication network system

(75) Inventor: Masamichi Ando, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: SUMITOMO HEAVY INDUSTRIES, LTD., Tokyo (JP)

(21) Appl. No.: 11/528,524

(22) Filed: Sep. 28, 2006

(51) Int. Cl. B01D 8/00; F25B 49/00

(52) U.S. Cl. 62/55.5; 62/228.1

(57) ABSTRACT

In a communication network system which unifies a system communication network and a master system communication network, each of a plurality of controlled devices is configured to transmit status data to a master controller and receive control data from the master controller so that the controlled device is operated based on the control data. The master controller comprises a control unit configured to receive status data of the controlled devices and transmit control data to the controlled devices, the control unit being configured to transmit the status data to a system controller and receive the control data from the system controller. The system controller comprises a second control unit configured to receive the status data of the controlled devices from the master controller, perform a processing operation based on the status data, and transmit a result of the processing operation to the master controller as the control data.

### CROSS-REFERENCE TO RELATED APPLICATION

This application is based upon Japanese Patent Application No. 2005-100624, which was filed on Mar. 31, 2005, the entire contents of which are incorporated herein by reference.

### BACKGROUND OF THE INVENTION

1. Field of the Invention

This invention relates to a communication network system for use in a semiconductor fabrication device including a cryopump system, in which a communication network of cryopump system and a communication network of master system are unified to share status and control information in the cryopump system and the master system.

2. Description of the Related Art

In order to perform vacuum evacuation of a chamber of a semiconductor fabrication device or the like, a cryopump (cryogenic vacuum pump) device is used. The cryopump device is provided with various components, such as sensors, valves, and motors. The cryopump device performs vacuum evacuation of the chamber of the semiconductor fabrication device by controlling these components.

Generally, one semiconductor fabrication device is provided with a plurality of cryopump devices, and it is necessary to construct the system for operating and controlling the plurality of cryopump devices.

FIG. 3 shows the composition of a conventional communication network system.

As shown in FIG. 3, a communication network system of master system which performs operation and control of the whole device, and another communication network system of cryopump system which performs vacuum evacuation of a chamber of a semiconductor fabrication device are constituted in the semiconductor fabrication device.

The master system 100 comprises a master controller (master device) 102, and various devices (slave devices) 103, which are both connected to a main bus 101. The master controller 102 is provided to control the whole device. The master controller 102 and the various devices 103 constitute a master system network 104.

The cryopump system 110 comprises a cryopump system controller (local master device) 111, a number of cryopump devices (local slave devices) 112, and a number of compressor devices (local slave devices) 113. The cryopump devices 112 and the compressor devices 113 are connected directly to the cryopump system controller 111. The cryopump system controller 111, the cryopump devices 112, and the compressor devices 113 constitute a cryopump system network 114.

The two system networks are linked by leased communication lines (not shown), and communication between the two system networks is performed by using a communication command 115 transmitted on the leased communication lines.

In the conventional communication network system, the communication network of the cryopump system 110 is provided independently. The communication command 115 sent from the master system 100 is received at the cryopump system controller 111 which is the local master device. The cryopump system controller 111 performs directly operation and control of the cryopump devices 112 and the compressor devices 113 based on the received command.

In the above-described conventional communication network system, the master system 100 is capable of acquiring information related to the processes of the cryopump system 110 only through the cryopump system controller 111. For this reason, there is a restriction in sharing information of the two system networks.

Moreover, it is necessary to arrange the two communication lines between the system networks 104 and 114 within the semiconductor fabrication device. It is expected that the cost will be increased and the space for accommodating the cables will be increased.

To obviate the above problems, it is conceivable that the communication network of the cryopump system 110 and the communication network of the master system 100 are arranged in a parallel formation so that they are unified together. Use of the parallel formation of the two communication networks will enable the master system 100 to acquire information related to the processes of the cryopump system 110 directly and in real time. Moreover, it is adequate to use one communication line between the system networks 104 and 114 within the semiconductor fabrication device, and the cost may be reduced.

For example, Japanese Laid-Open Patent Application No. 2000-073949 discloses an example of the unified communication network mentioned above.

Conventionally, the wide-area network system, such as a cluster tool for a semiconductor fabrication device, includes a host controller which performs control of the whole cluster tool for the semiconductor fabrication device. Generally, the communication between a conventional vacuum system and a tool host controller which controls the cluster tool is performed using the RS-232 protocol. The conventional vacuum system is provided with a network interface terminal which performs the communication between the conventional vacuum system and the cryopump system network using the known bit-bus protocol.

Other components of the vacuum system generally are connected to the host controller, and the tool host controller sends a command for controlling the operation of the components of the vacuum system.

In order to eliminate the above problems and facilitate the adjustments to the components of the vacuum system which operates using different communication protocols, there is proposed a communication network system which is constituted as follows.

The vacuum network controller comprises a computer (processor), a computer-readable recording medium on which a computer-readable program is stored, a host interface provided for communicating with the host controller, and a component interface provided for communicating with the vacuum system components. Both the host interface and the component interface are adapted to communicate with the computer, similar to the computer-readable recording medium. When executed by the computer, the computer-readable program stored on the computer-readable recording medium causes the computer to perform the following steps including the step of generating a plurality of commands to control the vacuum system components having the interface with the component interface, the step of converting the commands into commands conforming with a plurality of communication protocols, and the step of transmitting the converted commands to the component interface.

However, in the case of the conventional communication network system, the development of a unified system for assigning the functions of the cryopump system controller to operate and control the pumps and the compressors to the master controller will require a very high cost. It is not so realistic when such a restriction that a unified system must be developed only with modifications of the existing systems is assumed.

To obviate the problem, it is conceivable to configure a multi-master system so that the cryopump system controller used in the conventional communication network system, is connected with the master communication network in a parallel formation. In this configuration, the cryopump system controller also exists on the master communication network, while the multi-master system can take charge of the operating and controlling functions of the cryopump devices and the compressor devices.

However, the multi-master system according to the above configuration usually has a plurality of master controllers existing on the unified network and requires a large amount of wiring. Accomplishing the development and design of the multi-master system will be a difficult task. Moreover, the period needed for developing the multi-master system usually becomes considerably long, and feasibility of the multi-master system is low.

### SUMMARY OF THE INVENTION

According to one aspect of the invention, there is provided an improved communication network system in which the above-mentioned problems are eliminated.

According to one aspect of the invention, there is provided a communication network system which is adapted for reducing the amount of modifications and the amount of wiring that are required when unifying different communication networks.

According to one aspect of the invention, there is provided a communication network system which is adapted for reducing the amount of modifications and the amount of wiring that are required when unifying a communication network of cryopump system and a communication network of master system.

In an embodiment of the invention which solves or reduces one or more of the above-mentioned problems, there is provided a communication network system in which a communication network of a system, including a system controller and a plurality of first controlled devices, and a different communication network of a master system, including a master controller and a plurality of second controlled devices, are unified to form a unified communication network, wherein each of the plurality of first controlled devices is configured to transmit status information of the first controlled device to the master controller, and receive control information of the first controlled device from the master controller, so that the first controlled device is operated based on the received control information, wherein the master controller comprises a control unit which is configured to receive status information of the plurality of first controlled devices and transmit control information to the plurality of first controlled devices, the control unit being configured to transmit the status information of the plurality of first controlled devices to the system controller and receive the control information of the plurality of first controlled devices from the system controller, and the control unit being configured to transmit control information of the system controller to the system controller and receive system status information of the system controller from the system controller, wherein the system controller comprises a second control unit which is configured to receive the status information of the plurality of first controlled devices from the master controller, perform a processing operation based on the received status information, and transmit a result of the processing operation to the master controller as the control information of the plurality of first controlled devices, the second control unit being configured to transmit the system status information of the system controller to the master controller, and receive the control information of the system controller from the master controller, so that the system controller is operated based on the received control information.

The above-mentioned communication network system may be configured so that the plurality of first controlled devices include a number of cryopumps and a number of compressors, the system controller is a cryopump system controller controlling the plurality of first controlled devices, the first communication network of the system is a communication network of a cryopump system including the cryopump system controller, the cryopumps and the compressors, and the communication network of the cryopump system and the second communication network of the master system are unified to be the unified communication network.

The above-mentioned communication network system may be configured so that the cryopump system controller, the cryopumps, and the compressors are arranged on the unified communication network as being slave devices of the master controller.

The above-mentioned communication network system may be configured so that the master controller is configured so that the master controller controls directly the plurality of first controlled devices.

The above-mentioned communication network system may be configured so that the status information of the plurality of first controlled devices is status information indicating status of the cryopumps and the compressors, the status information being transmitted to the cryopump system controller through the master controller, and the control information being generated by the cryopump system controller and transmitted to the cryopumps and the compressors through the master controller.

The above-mentioned communication network system may be configured so that the status information of the plurality of first controlled devices is status information indicating status of the cryopumps and the compressors, the status information being transmitted to the master controller, and the control information being received from the cryopump system controller at the master controller and transmitted from the master controller to the cryopumps and the compressors.

The above-mentioned communication network system may be configured so that the status information of the plurality of first controlled devices is status information indicating status of the cryopumps and the compressors, the status information being transmitted to the master controller, and each of the cryopumps and the compressors is operated in accordance with the control information being received from the master controller.

The above-mentioned communication network system may be configured so that the status information and the control information are configured to be table-format information which is in conformity with the unified communication network.

The above-mentioned communication network system may be configured so that the communication network system further comprises a common main bus to which the plurality of first controlled devices, the system controller, the plurality of second controlled devices, and the master controller are connected.

The above-mentioned communication network system may be configured so that the unified communication network is constructed using one of communication protocols of Devicenet, Ethernet, CC-link, RS-485, and GPIB (general purpose interface bus).

In the present specification, unifying different communication networks means that the different communication networks are linked together so that communication between the networks can be performed using a common communication protocol. For example, it means that the main buses of the two communication networks are combined together to form a common main bus, and communication between the networks on the common main bus is performed using the common communication protocol.

According to the communication network system in an embodiment of the invention, different communication networks are unified into one communication network so that sharing of the status information in the two networks and integrated management of the shared information can be carried out using the master controller. The integrated management of the shared information will ensure the reliability of the unified communication network system.

According to the communication network system in an embodiment of the invention, the master controller and the slave devices are connected to the common main bus, so that the amount of wiring can be reduced and the space for accommodating the wires or cables can be decreased.

The communication network system in an embodiment of the invention is configured to be a single-master system, and the software included in the unified system can be simplified and the development period can be reduced. All the component devices in the unified system are connected to the common main bus so that a single-master system is constituted. Any of various communication protocols, such as Devicenet protocol, may be used to construct the unified communication network.

### BRIEF DESCRIPTION OF THE DRAWINGS

Other objects, features and advantages of the present invention will be apparent from the following detailed description when read in conjunction with the accompanying drawings.

FIG. 1 is a diagram showing the composition of the communication network system in an embodiment of the invention.

FIG. 2 is a diagram for explaining a communication data flow of the communication network system in an embodiment of the invention.

FIG. 3 is a diagram showing the composition of a conventional communication network system.

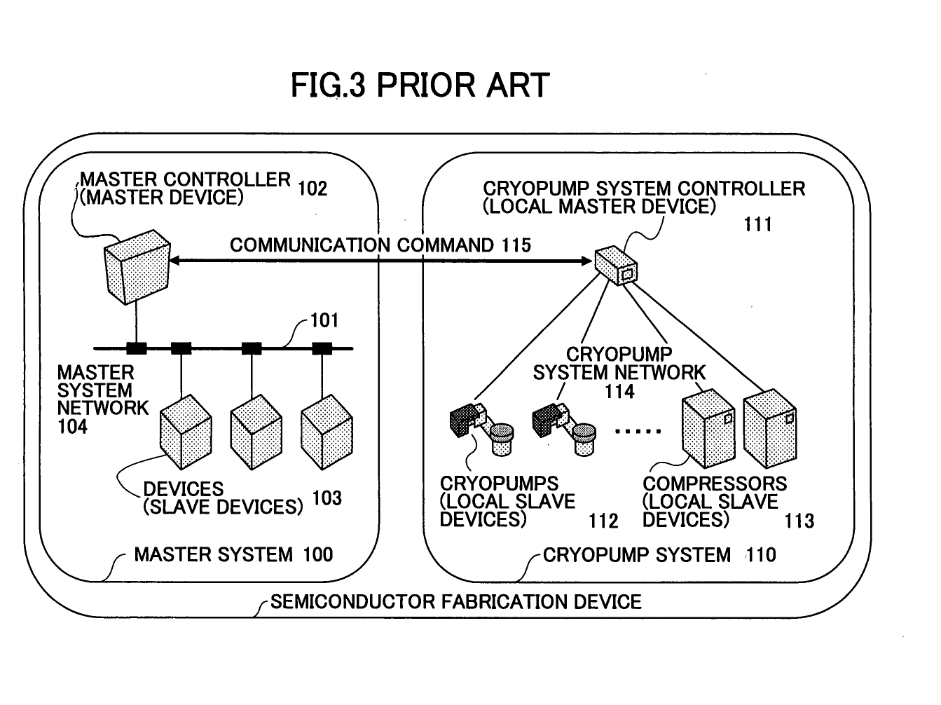

### DETAILED DESCRIPTION OF PREFERRED EMBODIMENTS

A description will be provided of the preferred embodiments of the present invention with reference to the accompanying drawings.

In the following, unifying different communication networks means that the different communication networks are linked together so that communication between the networks can be performed using a common communication protocol. For example, it means that the main buses of the two communication networks are combined together to form a common main bus, and communication between the networks on the common main bus is performed using the common communication protocol.

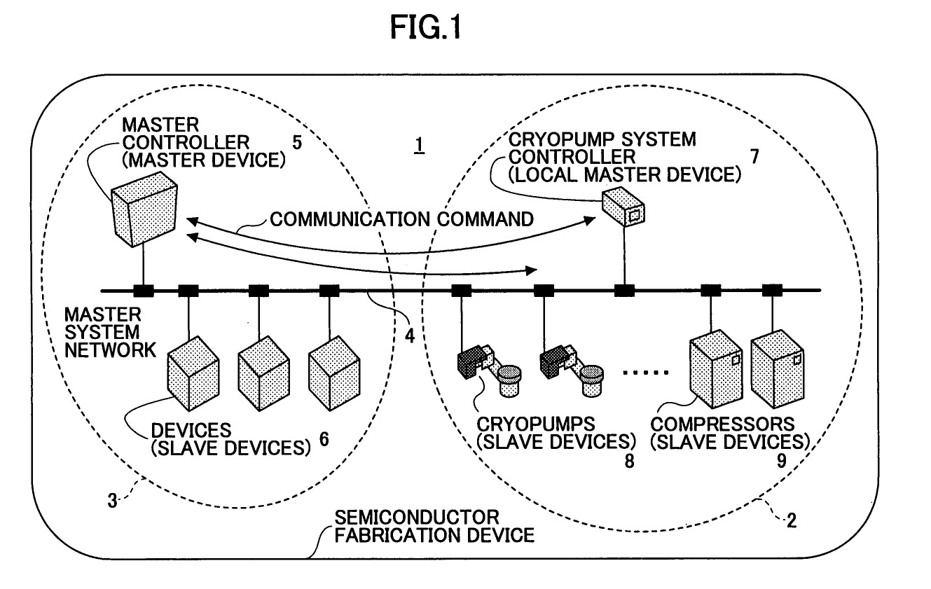

FIG. 1 shows the composition of the communication network system in an embodiment of the invention, which is appropriate for use in a semiconductor fabrication device.

As shown in FIG. 1, the communication network system 1 comprises a communication network of cryopump system 2 and a communication network of master system 3 which are linked in a parallel formation. Specifically, all the component devices in the cryopump system 2 and the master system 3 are connected to a common main bus 4, so that a unified communication network of the communication network system 1 is constituted.

A master controller (master device) 5 and a plurality of devices (slave devices) 6 which form the communication network of master system 3 are connected to the common main bus 4. And a cryopump system controller (local slave device) 7, a plurality of cryopumps (local slave devices) 8, and a plurality of compressors (local slave devices) 9 which form the communication network of cryopump system 2 are also connected to the common main bus 4.

When two or more cryopump systems 2 are needed for the communication network system 1 of FIG. 1, the communication network including the cryopump systems 2 with two or more cryopump system controllers (local master devices) 7 is further connected to the common main bus 4.

In the communication network system 1 of this embodiment, the master system 3 can acquire information related to the status and processes of the cryopump system 2 directly and in real time. Moreover, using one communication line between the cryopump system 2 and the master system 3 is adequate for the communication network system 1 of this embodiment, and the cost can be reduced.

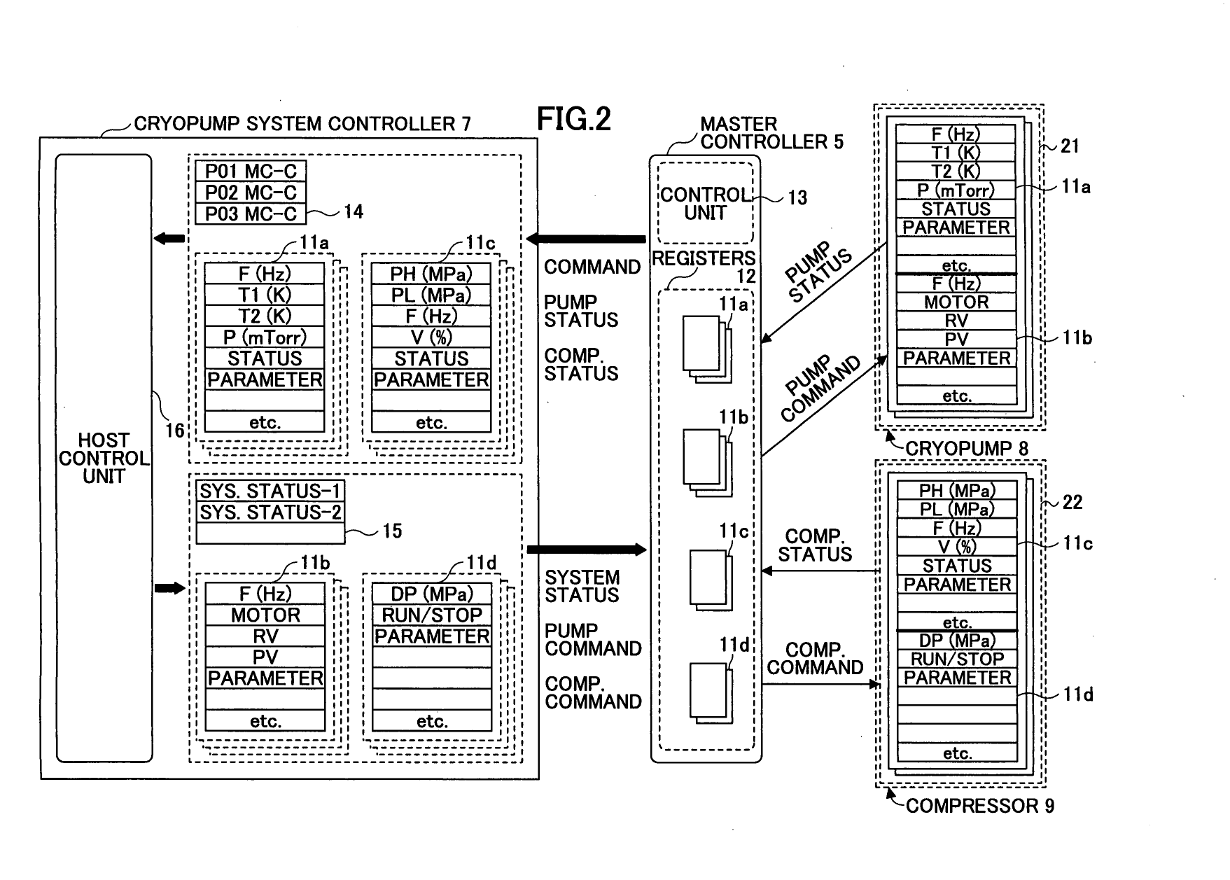

FIG. 2 is a diagram for explaining a communication data flow of the communication network system in an embodiment of the invention.

As shown in FIG. 2, the master controller 5 comprises registers 12, a control unit 13, and a communication unit (not shown). In the registers 12, status information 11a related to status of the cryopumps 8, status information 11c related to status of the compressors 9, control information (or command information) 11b related to control of the cryopumps 8, and control information (or command information) 11d related to control of the compressors 9 are stored in a table format.

The communication unit of the master controller 5 performs communication between the master controller 5 and the cryopumps 8 or the compressors 9, and performs communication between the master controller 5 and the cryopump system controller 7. The control unit 13 receives the status information of each of the slave devices (the cryopumps 8 and the compressors 9) using the communication unit. And the control unit 13 transmits the command information from the registers 12 to each of the slave devices (the cryopumps 8 and the compressors 9) using the communication unit.

It is preferred that each of the slave devices (the cryopumps) 8 includes a memory unit 21 for storing the table-format status information 11a and the table-format control information 11b, and each of the slave devices (the compressors) 9 includes a memory unit 22 for storing the table-format status information 11c and the table-format command information 11d, as shown in FIG. 2.

The master controller 5 serves as a master device in the master system network which manages the information in the master system network. The master controller 5 performs an intermediary task which manages the transmission and receiving of the status information and the command information between the cryopumps 8 (or the compressors 9) and the cryopump system controller 7. Moreover, the master controller 5 manages the transmission and receiving of system status information and command information between the master controller 5 and the cryopump system controller 7.

Each of the cryopumps 8 comprises a cryopump body (not shown), the memory unit 21, an operation unit (not shown), and a communication unit (not shown). The operation unit of each cryopump 8 operates the cryopump body in accordance with the table-format command information received from the master controller 5. The memory unit 21 includes a status memory area in which a pump status table (the status information 11a) is stored, and a command memory area in which a pump command table (the command information 11b) is stored.

Each of the cryopumps 8 receives the pump command table from the master controller 5 using the communication unit, and stores the pump command table into the memory unit 21. And the cryopump 8 reads the pump command table from the memory unit 21 and controls the cryopump body in accordance with the read pump command table. Then, the cryopump 8 writes measurement data of respective components of the cryopump body as a result of the control, to the pump status table 11a in the status memory area. The contents of the pump status table are updated to keep the latest status of the cryopump 8 concerned. The cryopump 8 transmits the status information 11a (the pump status table) to the master controller 5 in response to a call of status information request sent from the master controller 5.

An example of the pump status table (the status information 11a) is as follows:

the frequency of the pump of the refrigeration unit (F(Hz));

the temperature of the first stage (T1(K));

the temperature of the second stage (T2(K));

the internal pressure (P(mTorr));

the operating condition (Status); and

other variables (Parameter).

An example of the pump command table (the control information 11b) is as follows:

the command frequency (F(Hz));

the operating condition of the motor (Motor);

the rough valve (RV);

the purge valve (PV); and

other variables (Parameter).

Each of the compressors 9 comprises a compressor body (not shown), the memory unit 22, an operation unit (not shown), and a communication unit (not shown). The operation unit of each compressor 9 operates the compressor body in accordance with the table-format command information received from the master controller 5. The memory unit 22 includes a status memory area in which a compressor status table (the status information 11c) is stored, and a command memory area in which a compressor command table (the command information 11d) is stored.

Each of the compressors 9 receives the compressor command table from the master controller 5 using the communication unit, and stores the compressor command table into the memory unit 22. And the compressor 9 reads the compressor command table from the memory unit 22 and controls the compressor body in accordance with the read compressor command table. Then, the compressor 9 writes measurement data of respective components of the compressor body as a result of the control, to the compressor status table 11c in the status memory area of the memory unit 22. The contents of the compressor status table are updated to keep the latest status of the compressor 9 concerned. The compressor 9 transmits the status information 11c (the compressor status table) to the master controller 5 in response to a call of status information request sent from the master controller 5.

An example of the compressor status table (the status information 11c) is as follows:

the upper-limit pressure (PH(MPa));

the lower-limit pressure (PL(MPa));

the frequency of the motor of the compressor (F(Hz));

the opening ratio of the bypass valve (V(%));

the operating condition (Status); and

other variables (Parameter).

An example of the compressor command table (the control information 11d) is as follows:

the command frequency (DP(Hz));

the operating condition (Run/Stop); and

other variables (Parameter).

The cryopump system controller 7 comprises a memory unit, a host control unit 16, and a communication unit (not shown). The memory unit of the cryopump system controller 7 includes the pump status table 11a, the pump command table 11b, the compressor status table 11c, the compressor command table 11d, a master-controller command table 14 (in which command information received from the master controller is stored), and a system status table 15 (which indicates the status of the cryopump system controller 7).

It is preferred that, except the master-controller command table 14 and the system status table 15, the memory unit includes a corresponding number of the pump command or status tables for the number of the cryopumps 8 included in the cryopump system 2, and includes a corresponding number of the compressor command or status tables for the number of the compressors 9 included in the cryopump system 2.

The host control unit 16 is constituted by a processing unit, such as a microprocessor. The host control unit 16 generates system status data which indicates the status of the cryopump system controller 7, and stores the generated system status data into the system status table 15. The host control unit 16 accesses the master-controller command table 14 in which the command information received from the master controller 5 is stored, reads the command information from the master-controller command table 14, and changes the processing operation of the host control unit 16 in accordance with the read command information.

After the processing operation of the host control unit 16 is changed, the host control unit 16 accesses the pump status table 11a and the compressor status table 11c to acquire the necessary data. The host control unit 16 performs a processing operation based on the acquired data, to generate the pump control data and the compressor control data, and stores the pump control data and the compressor control data into the pump command table 11b and the compressor command table 11d in the memory unit.

By using the communication unit, the cryopump system controller 7 receives, from the master controller 5, the command information, the pump status information and the compressor status information, and stores them into the corresponding tables 14, 11a and 11c of the memory unit, respectively. Moreover, by using the communication unit, the cryopump system controller 7 transmits, to the master controller 5, the data of the system status table 15, the data of the pump command table 11b and the data of the compressor command table 11d, in response to a call of status information request sent from the master controller 5.

As shown in FIG. 1, in addition to the master controller (master device) 5, the cryopump system controller 7 is also connected to the common main bus 4 as a slave device of the master controller 5, similar to the other slave devices connected to the common main bus 4.

As shown in FIG. 2, the master controller 5 acquires the status information of the cryopumps 8 and the compressors 9, and transmits the status information to the cryopump system controller 7. The cryopump system controller 7 performs a processing operation based on the status information received from the master controller 5, and transmits the result of the processing operation to the master controller 5. The master controller 5 transmits the result of the processing operation received from the cryopump system controller 7, to each of the components (the cryopumps 8 and the compressors 9) as the command information. Each of the components performs the actual operation in accordance with the command information received from the master controller 5.

Accordingly, the communication network system of the present embodiment is configured to be a single-master system in which each of the respective components and the master controller 5 performs a one-to-one communication therebetween. What is required for the master system 3 is to have the register function to store temporarily the status information of the cryopumps 8 and the compressors 9. The software included in the master controller 5 can be simplified, and the development period can be reduced remarkably.

The command information transmitted to the cryopump system controller 7 by the master controller 5 primarily includes a stop/start command to the slave devices (the cryopumps 8 and the compressors 9) in the cryopump system 2.

The communication between the master controller 5 and each of the slave devices in the communication data flow of FIG. 2 is carried out using any of the existing communication methods, such as a master/slave system method and a peer-to-peer network method.

The master/slave system method is a method of communication to transmit and receive the status information and to transmit and receive the command information. The master/slave system method typically includes the following phases (1) to (5).

(1) The master controller 5 performs polling to the slave devices. In this step, the command information is transmitted from the master controller 5 to the corresponding one of the slave devices, and the status information is transmitted from the corresponding slave device to the master controller 5.

(2) The master controller 5 transmits a bit-strobe request to the slave devices. The message portion of the bit-strobe request includes an output data consisting of a number of bits (e.g., 64 bits or 8 bytes). Each of the bits is assigned for the MAC (media access control) ID (0, . . . , 63) on the network. Bit-strobe responses are returned to the master controller 5 from the corresponding nodes (slave devices).

(3) Each of the slave devices transmits the status information to the master controller 5 upon occurrence of an event.

(4) Each of the slave devices transmits the status information to the master controller 5 at intervals of a predetermined time which is set up by the user.

(5) The master controller 5 transmits to each of the slave devices a message which enables an operation command to be given to each slave device. For example, the message may include the address (the ID of the physical layer), the controlled object (class ID) and the service code (one-attribute data readout).

The peer-to-peer network method is a method of communication to transmit and receive messages for performing setting or diagnostic process of the slave devices.

The unified communication network for use in the communication network system in the embodiment of the invention may be constructed using any of various communication protocols including Devicenet protocol, Ethernet protocol, CC-link protocol, RS-485 protocol, and GPIB (general purpose interface bus; IEEE488) protocol.

Devicenet is a type of field network in which sensors, devices and controllers in a wide range of the field, excluding computers, are interlinked through a digital communication network. By using Devicenet, communication between various controlled devices can be easily realized in one network. A host device, such as a personal computer, can be connected as a master device. Sensors, actuators, I/O devices, gateway units and processing units can be connected as slave devices. Use of Devicenet allows reduction of the amount of wiring, such as I/O wires, analog signal lines, RS232C cables, RS422 cables, or other communication lines. Simplification of the wiring operation is possible.

The communication network system in the above-described embodiment is applicable to systems which require unifying of different communication networks. It is preferred to apply the communication network system in the above-described embodiment to a cryopump communication network for use in a semiconductor fabrication device in particular.

The present invention is not limited to the above-described embodiments, and variations and modifications may be made without departing from the scope of the present invention.

What is claimed is:

1. A communication network system in which a communication network of a system, including a system controller and a plurality of first controlled devices, and a different communication network of a master system, including a master controller and a plurality of second controlled devices, are unified to form a unified communication network,
wherein each of the plurality of first controlled devices is configured to transmit status information of the first controlled device to the master controller, and receive control information of the first controlled device from the master controller, so that the first controlled device is operated based on the received control information,
wherein the master controller comprises a control unit which is configured to receive status information of the plurality of first controlled devices and transmit control information to the plurality of first controlled devices, the control unit being configured to transmit the status information of the plurality of first controlled devices to the system controller and receive the control information of the plurality of first controlled devices from the system controller, and the control unit being configured to transmit control information of the system controller to the system controller and receive system status information of the system controller from the system controller,
wherein the system controller comprises a second control unit which is configured to receive the status information of the plurality of first controlled devices from the master controller, perform a processing operation based on the received status information, and transmit a result of the processing operation to the master controller as the control information of the plurality of first controlled devices, the second control unit being configured to transmit the system status information of the system controller to the master controller, and receive the control information of the system controller from the master controller, so that the system controller is operated based on the received control information.

2. The communication network system of claim 1 wherein the plurality of first controlled devices include a number of cryopumps and a number of compressors, the system controller is a cryopump system controller controlling the plurality of first controlled devices, the first communication network of the system is a communication network of a cryopump system including the cryopump system controller, the cryopumps and the compressors, and the communication network of the cryopump system and the second communication network of the master system are unified to be the unified communication network.

3. The communication network system of claim 2 wherein the cryopump system controller, the cryopumps, and the compressors are arranged on the unified communication network as being slave devices of the master controller.

4. The communication network system of claim 3 wherein the master controller is configured so that the master controller controls directly the plurality of first controlled devices.

5. The communication network system of claim 2 wherein the status information of the plurality of first controlled devices is status information indicating status of the cryopumps and the compressors, the status information being transmitted to the cryopump system controller through the master controller, and the control information being generated by the cryopump system controller and transmitted to the cryopumps and the compressors through the master controller.

6. The communication network system of claim 2 wherein the status information of the plurality of first controlled devices is status information indicating status of the cryopumps and the compressors, said status information being transmitted to the master controller, and the control information being received from the cryopump system controller at the master controller and transmitted from the master controller to the cryopumps and the compressors.

7. The communication network system of claim 2 wherein the status information of the plurality of first controlled devices is status information indicating status of the cryopumps and the compressors, said status information being transmitted to the master controller, and each of the cryopumps and the compressors is operated in accordance with the control information being received from the master controller.

8. The communication network system of claim 2 wherein the status information and the control information are configured to be table-format information which is in conformity with the unified communication network.

9. The communication network system of claim 1 further comprising a common main bus to which the plurality of first controlled devices, the system controller, the plurality of second controlled devices, and the master controller are connected.

10. The communication network system of claim 1 wherein the unified communication network is constructed using one of communication protocols of Devicenet, Ethernet, CC-link, RS-485, and GPIB (general purpose interface bus).
